(19) United States
(12) Patent Application Publication
(10) Pub. No.: US 2026/0110053 A1
(43) Pub. Date: Apr. 23, 2026

(54) METHOD FOR EXTRACTING ALUMINUM

(71) Applicants: HYUNDAI MOTOR COMPANY, Seoul (KR); KIA CORPORATION, Seoul (KR)

(72) Inventor: Jiyong Lee, Hwaseong-si (KR)

(73) Assignees: HYUNDAI MOTOR COMPANY, Seoul (KR); KIA CORPORATION, Seoul (KR)

(21) Appl. No.: 19/054,192

(22) Filed: Feb. 14, 2025

(30) Foreign Application Priority Data
Oct. 21, 2024 (KR) 10-2024-0143873

(51) Int. Cl. C22B 21/02; B22F 9/02; B22F 9/04; B33Y 70/00; C22B 5/02

(52) U.S. Cl. CPC C22B 21/02; B22F 9/023; B22F 9/04; B33Y 70/00; C22B 5/02; B22F 2009/043; B22F 2301/052; B22F 2998/10

(57) ABSTRACT

A method for extracting aluminum according to one embodiment of the present disclosure comprises a hydrogenation reaction step of an aluminum (Al) alloy; a separation step of NaAlH₄ generated from the hydrogenation reaction step; a dehydrogenation reaction step of the NaAlH₄; and a pure aluminum extraction step.

### CROSS-REFERENCE TO RELATED APPLICATION

This present application claims the benefit of and priority to Korean Patent Application No. 10-2024-0143873, entitled “Method of extracting aluminum” filed on Oct. 21, 2024, in the Korean Intellectual Property Office, the entire disclosure of which is incorporated herein by reference.

### FIELD

The present disclosure relates to a method for extracting aluminum.

### BACKGROUND

As internal combustion systems are converted to electric systems, components using primary aluminum are increasing. However, secondary aluminum contains many alloy elements such as Si, Cu, and Mg, making it difficult to be recycled as a primary material.

Therefore, there is a growing need for a technology for extracting expensive pure aluminum from a low-priced secondary aluminum alloy.

### SUMMARY

An aspect of the present disclosure is to provide a method for extracting expensive pure aluminum from a low-priced aluminum alloy.

In order to achieve the aspect, the present disclosure provides a method for extracting aluminum including: a hydrogenation reaction step of an aluminum (Al) alloy; a separation step of NaAlH₄ generated from the hydrogenation reaction step; a dehydrogenation reaction step of the NaAlH₄; and a pure aluminum extraction step.

In the method for extracting aluminum according to an example of the present disclosure, in the hydrogenation reaction step, the aluminum alloy may react with sodium hydride (NaH).

In the method for extracting aluminum according to an example of the present disclosure, in the NaAlH₄ separation step, the NaAlH₄ may be dissolved in a solvent.

In the method for extracting aluminum according to an example of the present disclosure, the solvent may dissolve only NaAlH₄.

In the method for extracting aluminum according to an example of the present disclosure, the solvent may be one or more of tetrahydrofuran (THF), dioxane, acetone, dimethyl sulfoxide (DMSO), dimethylformamide (DMF), 1-methyl-2-pyrrolidone (NMP), or any combination thereof.

In the method for extracting aluminum according to an example of the present disclosure, in the NaAlH₄ separation step, the NaAlH₄ may be dissolved in a solvent and then the dissolved NaAlH₄ solution (created by the NaAlH₄ being dissolved in the solvent) may be heated.

In the method for extracting aluminum according to an example of the present disclosure, the dehydrogenation reaction step may comprise heating the NaAlH₄ at a first temperature and separating remaining NaAlH₄ and NaH.

In the method for extracting aluminum according to an example of the present disclosure, the first temperature may be 95° C. or higher.

In the method for extracting aluminum according to an example of the present disclosure, the dehydrogenation reaction step may further comprise recapturing NaH and H₂.

In the method for extracting aluminum according to an example of the present disclosure, the dehydrogenation reaction step may comprise heating the NaAlH₄ at a second temperature and supplying hydrogen.

In the method for extracting aluminum according to an example of the present disclosure, the second temperature may be a sodium (Na) evaporation temperature or higher.

In the method for extracting aluminum according to an example of the present disclosure, the second temperature may be 882° C. or higher.

According to various examples of the present disclosure, the method for extracting aluminum can separate pure aluminum from an aluminum alloy containing a large amount of fine metallic elements. According to various examples of the present disclosure, the method for extracting aluminum can extract expensive pure aluminum from a low-priced aluminum alloy through a hydrogenation/dehydrogenation reaction of NaH.

According to various examples of the present disclosure, the method for extracting aluminum can recycle NaH, a solvent, hydrogen gas, and the like generated during an extraction process, so that the process is highly efficient and eco-friendly.

According to various examples of the present disclosure, the method for extracting aluminum can reduce CO₂ emissions by about 84% or more compared to conventional aluminum extraction methods.

The effects of the present disclosure are not limited to the aforementioned effects, and other effects, which are not mentioned above, should be apparent to those having ordinary skill in the art from the following description.

### BRIEF DESCRIPTION OF THE DRAWINGS

The above and other aspects, features, and advantages of the present disclosure should become apparent from the detailed description of the following aspects in conjunction with the accompanying drawings, in which:

FIG. 1 is a process flowchart of a method for extracting aluminum according to one example of the present disclosure;

FIG. 2 is a schematic diagram for describing a method for extracting aluminum according to one example of the present disclosure;

FIG. 3 illustrates an example of a hydrogenation reaction step and a NaAlH₄ separation step;

FIG. 4 is a process flowchart of a dehydrogenation reaction step according to one example of the present disclosure;

FIG. 5 is a process flowchart of a dehydrogenation reaction step according to another example of the present disclosure; and

FIG. 6 is a schematic diagram of describing the dehydrogenation reaction step according to the example of FIG. 5.

### DETAILED DESCRIPTION

Hereinafter, examples of the present disclosure are described in detail with reference to the accompanying drawings. Like or similar reference numerals designate like or similar elements in the following description, and the detailed description thereof may be omitted.

As used herein, the terms “comprising”, “including”, and “having” specify the presence of features, integers, steps, operations, elements, components, or combinations thereof disclosed on the present disclosure, but do not preclude any one of features, integers, steps, operations, elements, components, and/or combinations thereof in advance.

Various examples of the present disclosure relate to a method for extracting aluminum. Various examples of the present disclosure relate to a method for extracting expensive pure aluminum from a low-priced aluminum alloy.

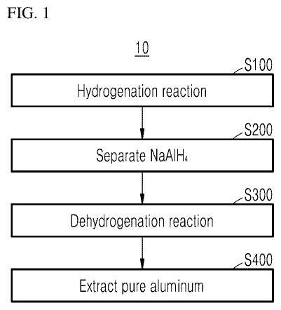

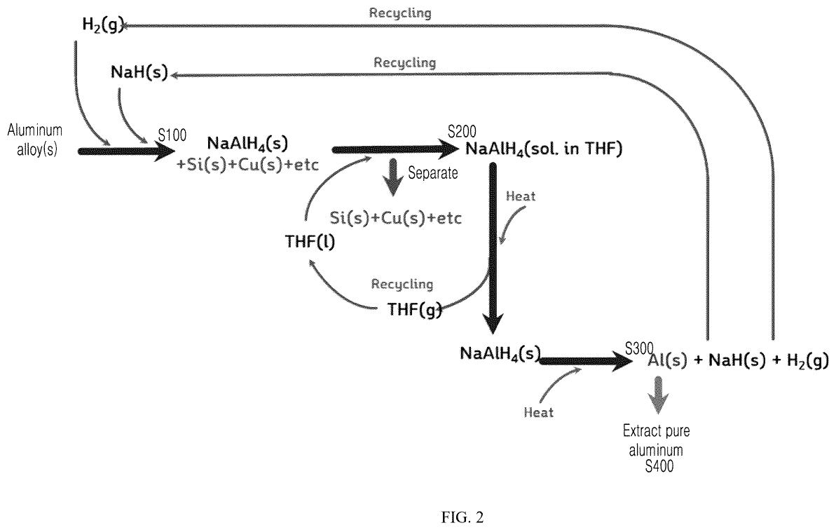

FIG. 1 is a process flowchart of a method for extracting aluminum according to an example of the present disclosure. FIG. 2 is a schematic diagram for describing a method for extracting aluminum according to an example of the present disclosure.

Referring to FIGS. 1 and 2, an aluminum extraction method 10 according to various examples of the present disclosure may comprise a hydrogenation reaction step (S100), a NaAlH₄ separation step (S200), a dehydrogenation reaction step (S300), and a pure aluminum extraction step (S400).

In the hydrogenation reaction step (S100), an aluminum alloy may react with sodium hydride (NaH). The aluminum alloy may be various aluminum alloys, such as cast aluminum, secondary aluminum, primary aluminum, and 3D printing aluminum powder. The aluminum alloy may be an alloy that further comprises a metallic element in addition to aluminum. For example, the aluminum alloy may mean an alloy that further comprises one or more of Si, Cu, Mg, Zn, Fe, Mn, Ni, Sn, or any combination thereof, in addition to aluminum.

The aluminum alloy may be in the form of a processed chip having a total length of 50 mm or less or a powder having a diameter of 5 mm or less.

In one example, NaH reacting with the aluminum alloy may be a single component. In one example, NaH may be a solid state.

The aluminum alloy and NaH may be prepared at a molar ratio of 1:1, for example.

In the hydrogenation reaction step (S100), hydrogen may be supplied. In the hydrogenation reaction step (S100), hydrogen may be supplied in a gaseous form. In the hydrogenation reaction step (S100), hydrogen may be supplied at a pressure of 80 bars to 90 bars. In the hydrogenation reaction step (S100), hydrogen may be supplied continuously.

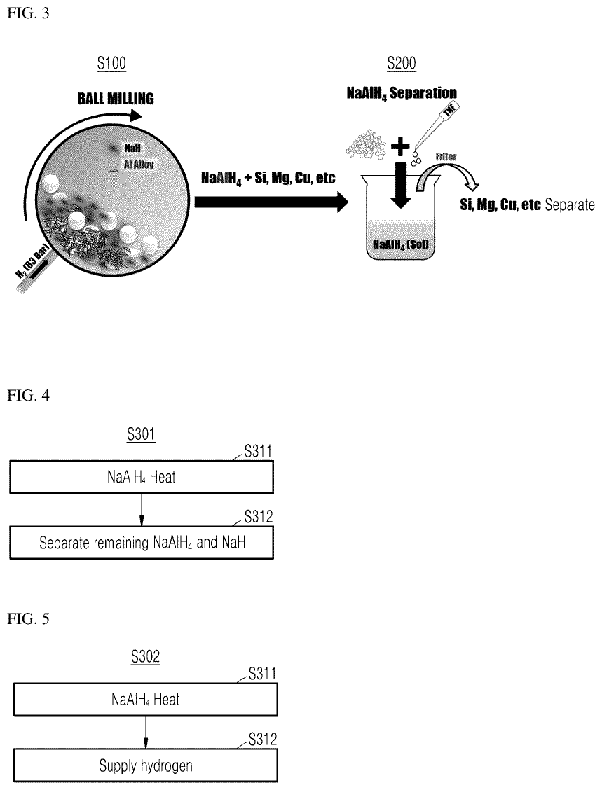

FIG. 3 illustrates an example of the hydrogenation reaction step (S100) and the NaAlH₄ separation step (S200). Referring to FIG. 3, the hydrogenation reaction step (S100) may be performed in a ball milling device. In the hydrogenation reaction step (S100), the reaction may be performed while charging an aluminum alloy and NaH into the ball milling device and supplying hydrogen gas.

In the hydrogenation reaction step (S100), a reaction according to the following Reaction Formula may occur. In other words, in the hydrogenation reaction step (S100), NaAlH₄ may be generated.

NaH(s)+aluminum alloy(s)+H₂(g)→NaAlH₄(s)+Si(s), Mg(s), Cu(s), Fe(s), and the like. Reaction Formula

Next, the NaAlH₄ separation step (S200) may be performed. In the NaAlH₄ separation step (S200), NaAlH₄ generated in the hydrogenation reaction step (S100) above may be separated.

In the NaAlH₄ separation step (S200), NaAlH₄ may be dissolved using a solvent. The solvent may be a solvent that dissolves NaAlH₄. For example, the solvent may be one or more of tetrahydrofuran (THF), dioxane, acetone, dimethyl sulfoxide (DMSO), dimethylformamide (DMF), 1-methyl-2-pyrrolidone (NMP), or any combination thereof. In one example, the solvent may be tetrahydrofuran. For example, the solvent may comprise a single component of tetrahydrofuran.

The solvent may dissolve NaAlH₄ and NaH in a solid state. The solvent may not react with trace metallic elements generated in the hydrogenation reaction step (S100). In other words, the solvent does not react with Si, Cu, Mg, Zn, Fe, Mn, Ni, Sn, and the like.

When the NaAlH₄ is dissolved with the solvent, the dissolution may be performed at a temperature of less than 66° C. At a temperature of 66° C. or higher, the solvent may be evaporated. When the NaAlH₄ is dissolved with the solvent, the dissolution may be maintained for at least 10 minutes.

In the NaAlH₄ separation step (S200), a reaction according to the following Reaction Formula may occur.

NaAlH₄(s)+solvent→NaAlH₄(sol) Reaction Formula

Referring to FIG. 3, in the NaAlH₄ separation step (S200), the NaAlH₄ dissolved in the solvent passes through a filter, and trace metallic elements that are not dissolved in the solvent may be separated by the filter.

Next, the NaAlH₄ solution dissolved in the solvent may be heated at a temperature of 66° C. or higher. Through this heating step, the solvent in the NaAlH₄ solution may be evaporated. By evaporating the solvent, only the NaAlH₄ may be separated. In one example, the evaporated solvent may be recaptured and recycled.

Next, in the dehydrogenation reaction step (S300), a reduction reaction of the separated NaAlH₄(s) may occur. The dehydrogenation reaction step (S300) may be performed according to various examples. A first example and a second example is described below.

FIG. 4 is a process flowchart of a dehydrogenation reaction step according to a first example. Referring to FIG. 4, a dehydrogenation reaction step (S301) according to a first example may comprise heating NaAlH₄ (S311) and separating remaining NaAlH₄ and NaH (S312).

In the heating of NaAlH₄ (S311), the NaAlH₄ separated in the NaAlH₄ separation step (S200) may be heated at a first temperature. The first temperature may be 95° C. or higher. In one example, the first temperature may be 97.5° C. or higher. In another example, the first temperature may be 97.9° C. or higher. Through the heating of NaAlH₄ (S311) at the first temperature, NaAlH₄ may be decomposed into NaH, Al, and H₂.

In the separating of the remaining NaAlH₄ and NaH (S312), the unreacted NaAlH₄ and NaH may be dissolved using a solvent. The solvent may be a solvent that dissolves only NaAlH₄ and NaH in a solid state. For example, the solvent may be one or more of tetrahydrofuran (THF), dioxane, acetone, dimethyl sulfoxide (DMSO), dimethylformamide (DMF), 1-methyl-2-pyrrolidone (NMP), or any combination thereof. In one example, the solvent may be tetrahydrofuran. For example, the solvent may comprise a single component of tetrahydrofuran.

The separating of the remaining NaAlH₄ and NaH (S312) may be performed at a temperature of less than 66° C. At a temperature of 66° C. or higher, the solvent may be evaporated. When the remaining NaAlH₄ and NaH are dissolved in the solvent, the dissolution may be maintained for at least 10 minutes.

In the separating of the remaining NaAlH₄ and NaH (S312), pure aluminum that is not dissolved in the solvent may be separated.

The dehydrogenation reaction step (S301) according to the first example may be performed by a ball milling process. The ball milling time may be within 5 hours. Through this, the carbon emissions may be reduced while maximally decomposing NaAlH₄. For example, the remaining NaAlH₄ that is not decomposed in the dehydrogenation reaction step (S301) according to the first example may be less than 10 wt % compared to initial NaAlH₄.

The separating of the remaining NaAlH₄ and NaH (S312) may further comprise recapturing NaH and H₂. The recaptured NaH and H₂ may be recycled and used in the hydrogenation reaction step (S100).

In the dehydrogenation reaction step (S301), a reaction according to the following Reaction Formula may occur. In the dehydrogenation reaction step (S301), a reduction reaction of NaAlH₄(s) may occur.

NaAlH₄(s)→NaH(s)+Al(s)+2H₂(g) Reaction Formula

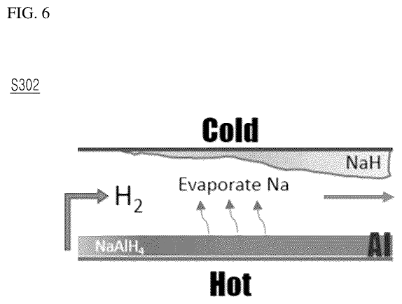

FIG. 5 is a process flowchart of a dehydrogenation reaction step according to a second example. FIG. 6 is a schematic diagram for describing the dehydrogenation reaction step according to the second example of FIG. 5.

Referring to FIG. 5, a dehydrogenation reaction step (S302) according to a second example may comprise heating NaAlH₄ (S311) and supplying hydrogen (S312).

Referring to FIG. 6, the dehydrogenation reaction step (S302) according to the second example may be performed in a reactor equipped with a cold upper plate (Cold) and a hot lower plate (Hot).

In the heating of NaAlH₄ (S311), the NaAlH₄ separated in the NaAlH₄ separation step (S200) may be heated at a second temperature. The second temperature may be equal to or higher than a sodium (Na) evaporation temperature. For example, the second temperature may be 882° C. or higher. In the heating of NaAlH₄ (S311), Na may be evaporated.

Referring to FIGS. 5 and 6, in the supplying of hydrogen (S312), the evaporated Na and hydrogen may react with each other. In other words, in the supplying of hydrogen (S312), the evaporated Na and hydrogen may react with each other to generate NaH according to the following Reaction Formula.

Na(g)+½H₂(g)→NaH(s) Reaction Formula

The NaH generated in the supplying of hydrogen (S312) may be accumulated on the cold upper plate (Cold). This NaH may be scraped off and reused.

Once the NaH generated in the supplying of hydrogen (S312) is removed, only pure aluminum may remain in the reactor. For example, pure aluminum may be accumulated on the hot lower plate (Hot) in the reactor.

Next, in the pure aluminum extraction step (S400), pure aluminum separated in the dehydrogenation reaction step (S300) may be extracted.

For example, in the separating of the remaining NaAlH₄ and NaH (S312) of the dehydrogenation reaction step (S301) according to the first example, pure aluminum not dissolved in the solvent is separated through filter paper, and the corresponding aluminum may be extracted.

After removing the NaH generated in the supplying of hydrogen (S312) of the dehydrogenation reaction step (S302) according to the second example, pure aluminum may be extracted.

According to various examples of the present disclosure, the method of extracting aluminum may separate pure aluminum from an aluminum alloy containing a large amount of fine metallic elements. According to various examples of the present disclosure, the method of extracting aluminum may extract expensive pure aluminum from a low-priced aluminum alloy through a hydrogenation/dehydrogenation reaction of NaH.

According to various examples of the present disclosure, the method of extracting aluminum may recycle NaH, a solvent, hydrogen gas, and the like generated during an extraction process, so that the process is highly efficient and eco-friendly.

According to various examples of the present disclosure, the method of extracting aluminum may reduce CO₂ emissions by about 84% or more compared to conventional aluminum extraction methods.

Hereinafter, the present disclosure is described in more detail by Examples. However, the following Examples and Experimental Examples are only intended to describe the present disclosure in more detail, and the scope of the present disclosure is not limited by the following Examples and Experimental Examples.

### Example

Various aluminum alloys having compositions shown in Table 1 were prepared.

TABLE 1

| | Composition (wt. %) | | | | | | | | | |
|---|---|---|---|---|---|---|---|---|---|---|
| Ex. | Cu | Si | Mg | Zn | Fe | Mn | Ni | Sn | Etc. | Al |
| Ex. 1 | 1.5~3.5 | 9.6~12.0 | 0.3 max. | 1.0 max. | 1.3 max. | 0.5 max. | 0.5 max. | 0.3 max. | 0.5 max. | Rem. |
| Ex. 2 | 0.35 max. | 0.2~0.6 | 0.45~0.9 | — | 0.1 max. | <0.1 | — | — | — | Rem. |
| Ex. 3 | 0.05 max. | 9.0~10.0 | 0.25~0.45 | 0.1 max. | 0.55 max | 0.45 max. | 0.05 max. | 0.05 amx. | — | Rem. |

Example 1 was ADCl2 (secondary aluminum). Example 2 was A6005 (primary aluminum). Example 3 was 3D printing powder. The aluminum alloys of Examples 1-3 were prepared in the form of processed chips with a total length of 50 mm or less or in the form of powders with a diameter of 5 mm or less.

The aluminum alloys of Examples 1-3 and NaH were charged into a ball milling device, and hydrogen gas was supplied at 83 Bar to induce a hydrogenation reaction.

As a result of the hydrogenation reaction, NaAlH₄(s) was generated. Since the aluminum alloy that participated in the reaction contained trace elements such as Si, Mg, Cu, and Fe in addition to aluminum, the corresponding trace elements were included after the hydrogenation reaction.

Next, NaAlH₄ was dissolved using tetrahydrofuran (THF) as a solvent. The NaAlH₄ solution passed through a filter. Since the solvent did not react with trace elements such as Si, Mg, Cu, and Fe, the corresponding trace elements were separated by a filter. The NaAlH₄ solution was heated at a temperature of 66° C. or higher to evaporate and recapture THF. Thereafter, solid NaAlH₄ remained.

Next, the solid NaAlH₄ was charged into the ball milling device again and applied with a temperature of 97.9° C. or higher. NaAlH₄ was decomposed into NaH(s), Al(s), and H₂(g). After the reaction was completed, H₂(g) was captured as gas, and solid pure aluminum, NaH(s), and unreacted NaAlH₄(s) remained. The remaining NaAlH₄(s) and NaH(s) were dissolved in THF, and pure aluminum was separated using filter paper. The NaH(s) and H₂(g) were recaptured and recycled.

### Experimental Example 1: Comparison of Carbon Dioxide Emissions

The carbon dioxide emissions of a conventional aluminum extraction method and an aluminum extraction method using ADCl2 (secondary aluminum) of Example 1 were compared. Specifically, according to the conventional aluminum extraction method, a graphite anode, a graphite cathode, and molten cryolite as an electrolyte were prepared in a steel tank and then electrolyzed.

A carbon oxidation reaction occurred at the anode as follows:

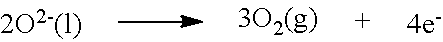

A carbon reduction reaction occurred at the cathode as follows:

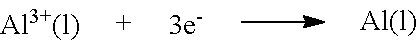

The overall Reaction Formula was as follows:

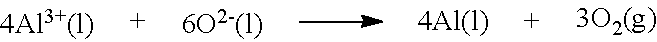

Molten aluminum was extracted through this reaction. The CO₂ emissions when extracting 1 kg of aluminum were 16 kg.

On the other hand, when the aluminum extraction method using ADC12 (secondary aluminum) of Example 1 was used, the CO₂ emissions when extracting 1 kg of aluminum were 2.5 kg.

In other words, it was confirmed that aluminum extraction methods of the Examples above could reduce the CO₂ emissions by about 84% compared to the conventional aluminum extraction method.

Hereinabove, the examples of the present disclosure have been described together with the drawings. The examples are illustrative, and the present disclosure is not limited to the above-described examples and the contents of the drawings.

It should be apparent to those having ordinary skill in the art that modifications of the present disclosure may be made within the scope of the disclosed technical idea. The described examples should be considered as part of the present disclosure, and the scope of the present disclosure should not be limited only to the described examples.

The scope of the present disclosure should be judged by the technical ideas set forth in the appended claims. In addition, even if the actions or effects according to the configuration are not explicitly described while explaining the embodiments of the present disclosure, it is understood that the actions or effects that may be predicted by the configuration should also be recognized as the present disclosure.

1. A method for extracting aluminum comprising:
a hydrogenation reaction step of an aluminum (Al) alloy;
a separation step of NaAlH₄ generated from the hydrogenation reaction step;
a dehydrogenation reaction step of the NaAlH₄; and
a pure aluminum extraction step.

2. The method for extracting aluminum of claim 1, wherein in the hydrogenation reaction step, the aluminum alloy reacts with sodium hydride (NaH).

3. The method for extracting aluminum of claim 1, wherein in the separation step of NaAlH₄, the NaAlH₄ is dissolved in a solvent.

4. The method for extracting aluminum of claim 3, wherein the solvent dissolves only NaAlH₄.

5. The method for extracting aluminum of claim 3, wherein the solvent is one or more of tetrahydrofuran (THF), dioxane, acetone, dimethyl sulfoxide (DMSO), dimethylformamide (DMF), 1-methyl-2-pyrrolidone (NMP), or any combination thereof.

6. The method for extracting aluminum of claim 1, wherein in the separation step of NaAlH₄, the NaAlH₄ is dissolved in a solvent to create a dissolved NaAlH₄ solution, and wherein the method further comprises heating the dissolved NaAlH₄ solution.

7. The method for extracting aluminum of claim 1, wherein the dehydrogenation reaction step comprises:
heating the NaAlH₄ at a first temperature; and
separating remaining NaAlH₄ and NaH.

8. The method for extracting aluminum of claim 7, wherein the first temperature is 95° C. or higher.

9. The method for extracting aluminum of claim 7, wherein the dehydrogenation reaction step further comprises recapturing NaH and H₂.

10. The method for extracting aluminum of claim 1, wherein the dehydrogenation reaction step comprises:
heating the NaAlH₄ at a second temperature; and
supplying hydrogen.

11. The method for extracting aluminum of claim 10, wherein the second temperature is a sodium (Na) evaporation temperature or higher.

12. The method for extracting aluminum of claim 10, wherein the second temperature is 882° C. or higher.
